(19) United States
(12) Patent Application Publication
(10) Pub. No.: US 2026/0179978 A1
(43) Pub. Date: Jun. 25, 2026

(54) FUEL CELL MODULE

(71) Applicant: TOYOTA JIDOSHA KABUSHIKI KAISHA, Toyota-shi (JP)

(72) Inventor: Hidefumi NAKAO, Yokohama-shi (JP)

(73) Assignee: TOYOTA JIDOSHA KABUSHIKI KAISHA, Toyota-shi (JP)

(21) Appl. No.: 19/328,567

(22) Filed: Sep. 15, 2025

(30) Foreign Application Priority Data
Dec. 24, 2024 (JP) 2024-227391

(51) Int. Cl. H01M 8/04014; H01M 8/0236; H01M 8/12

(52) U.S. Cl. CPC H01M 8/04022; H01M 8/0236; H01M 8/12; H01M 2008/1293

(57) ABSTRACT

A fuel cell module according to an aspect of the present disclosure includes a housing having an internal space, a fuel cell, and a combustor. The internal space includes a first space, a second space that is continuous with the first space, and a third space that is continuous with the second space and is connected to the first space via the second space, the fuel cell is disposed in the first space, the combustor is disposed in the second space; the second space is configured to allow a first gas discharged from the first space to flow in, and the third space is configured to allow a second gas discharged from the second space to flow in, and a discharge port for discharging the second gas to an outside of the housing is provided in a housing portion of the third space.

### CROSS-REFERENCE TO RELATED APPLICATION

This application claims priority to Japanese Patent Application No. 2024-227391 filed on Dec. 24, 2024. The disclosure of the above-identified application, including the specification, drawings, and claims, is incorporated by reference herein in its entirety.

### BACKGROUND

### 1. Technical Field

The present disclosure relates to a fuel cell module.

### 2. Description of Related Art

Japanese Unexamined Patent Application Publication No. 2022-073358 (JP 2022-073358 A) proposes a fuel cell power generation system including a fuel cell and a combustor.

### SUMMARY

One object of the present disclosure is to provide a technique for reducing a warm-up time of a fuel cell.

A fuel cell module according to the present disclosure includes: a housing including an internal space; a fuel cell; and a combustor, wherein: the internal space includes a first space, a second space continuous with the first space, and a third space continuous with the second space and connected to the first space via the second space; the fuel cell is disposed in the first space; the combustor is disposed in the second space; the second space is configured to allow inflow of a first gas discharged from the first space; and the third space is configured to allow inflow of a second gas discharged from the second space, and a discharge port for discharging the second gas to an outside of the housing is provided in a housing portion of the third space.

According to the present disclosure, it is possible to reduce the warm-up time of the fuel cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically shows an example of a fuel cell system of the present disclosure;

FIG. 2 schematically shows an example of a fuel cell module of the present disclosure;

FIG. 3 is a flowchart showing an example of a processing procedure of a control device at the time of activation of the fuel cell module of the present disclosure; and

FIG. 4 is a flowchart showing an example of a processing procedure of the control device in a steady state of the fuel cell module of the present disclosure.

### DETAILED DESCRIPTION OF EMBODIMENTS

For example, in a system in the related art such as JP 2022-073358 A resources generated in a process of fuel cell power generation are stored in a resource storage unit. The stored resources are configured to be supplied to the fuel cell or a peripheral device. With the system, it is possible to reduce the cost of fuel cell power generation by using the stored resources. However, in the system in the related art, it is not possible to improve energy efficiency at the time of activation of the fuel cell. In particular, a fuel cell such as a solid oxide fuel cell takes time to reach an operating temperature of 700° C. or higher from activation. As a result, the efficiency of fuel cell power generation may be reduced.

On the other hand, a fuel cell module according to the present disclosure includes a housing having an internal space, a fuel cell, and a combustor. The internal space includes a first space, a second space that is continuous with the first space, and a third space that is continuous with the second space and is connected to the first space via the second space, the fuel cell is disposed in the first space, the combustor is disposed in the second space, the second space is configured to allow inflow of a first gas discharged from the first space, the third space is configured to allow inflow of a second gas discharged from the second space, and a discharge port for discharging the second gas to an outside of the housing is provided in a housing portion of the third space. With the configuration, the second space in which the combustor is disposed is adjacent to the first space in which the fuel cell is disposed. As a result, at the time of activation of the fuel cell, the combustor can drive the gas turbine by burning the fuel gas and can transmit thermal energy to the first space. Therefore, the fuel cell can promptly complete warm-up by obtaining the transmitted thermal energy. As a result of the early warm-up of the fuel cell being possible, the waiting time of the fuel cell is reduced, and thus the fuel cell system can expect to improve the power generation efficiency.

Hereinafter, an embodiment according to one aspect of the present disclosure will be described with reference to the drawings. Meanwhile, the present embodiment to be described below is merely an example of the present disclosure in all respects. Various improvements and modifications may be made without departing from the scope of the present disclosure. That is, in the implementation of the present disclosure, a specific configuration according to the embodiment may be appropriately adopted.

### 1. Configuration Example

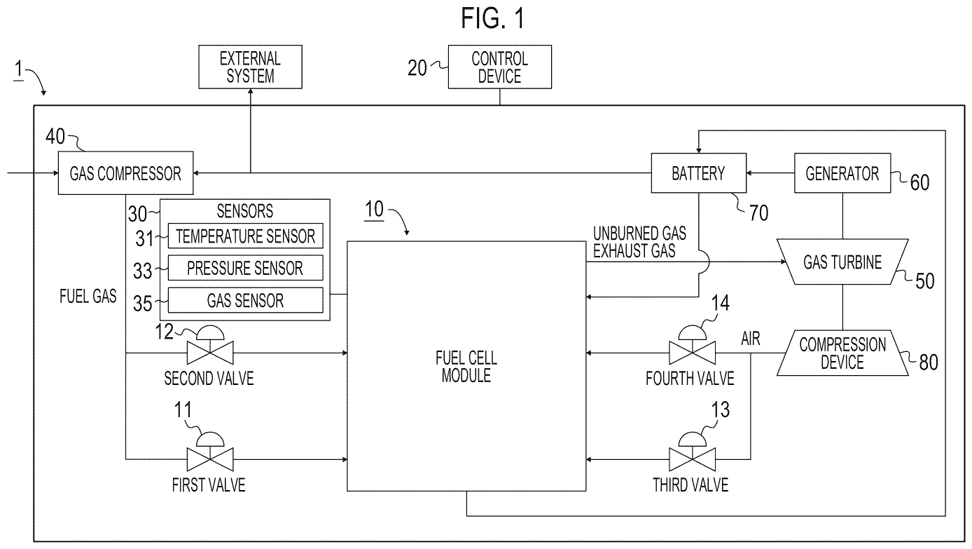

FIG. 1 schematically shows an example of a fuel cell system 1 (gas turbine fuel cell combined power generation system) of the present disclosure. The fuel cell system 1 is configured of a fuel cell module 10, a control device 20, a sensor 30, a gas compressor 40, a gas turbine 50, a generator 60, a battery 70, and a compression device 80. The fuel cell module 10 uses the fuel gas supplied from the gas compressor 40 for power generation by the fuel cell. The electric power generated may be stored in the battery 70. In addition, the discharge gas (exhaust gas) or the unburned gas generated by the power generation may be supplied to the gas turbine 50. The gas turbine 50 is driven using the supplied high-temperature gas as an energy source. The rotation energy of the driven gas turbine 50 is transmitted to the generator 60. The generator 60 converts the rotation energy of the gas turbine 50 into electric power. The electric power generated by the generator 60 may also be stored in the battery 70. The electric power stored in the battery 70 may be used for an external system and a device (an ignition device or the like) in the fuel cell module 10. The sensor 30 detects a state in the fuel cell module 10. The control device 20 controls each of the components of the fuel cell system 1 based on the detection result of the sensor 30.

### Fuel Cell System

The fuel cell system 1 is a power generation system including a fuel cell module 10 to be described later. The configuration of the fuel cell system 1 is not particularly limited as long as the fuel cell module 10 is included, and may be appropriately selected according to the embodiment. The fuel cell system 1 may be configured solely by the fuel cell module 10, or may be configured by combining the fuel cell module 10 with another power generation system. In an example, the other power generation system may be a power generation system (gas turbine power generation) using a gas turbine. In the present embodiment, the fuel cell system 1 is a gas turbine fuel cell combined power generation system in which the fuel cell module 10 and the gas turbine power generation are combined as described above. The gas turbine fuel cell combined power generation system can improve the power generation efficiency by supplying the gas discharged from the fuel cell to the gas turbine, reusing the exhaust heat of the gas turbine in the fuel cell, and the like. In addition, the use of the fuel cell system 1 may include any use, such as a home use, a commercial use, an industrial use, and a use for a moving body. The moving body may include a vehicle, a train, an airplane, and a ship.

### Control Device

The configuration of the control device 20 is not particularly limited as long as each of the components of the fuel cell system 1 can be controlled, and may be appropriately selected. In an example, the control device 20 may be a computer in which a controller, a storage unit, and an external interface are electrically connected. The controller may be configured to execute any information processing, and may include a central processing unit (CPU), a random access memory (RAM), a read only memory (ROM), or the like. The storage unit may be constituted by, for example, a hard disk drive or a solid state drive. The external interface may be, for example, a universal serial bus (USB) port, a dedicated port, or a wireless communication port, and is configured to connect to an external device by wire or wirelessly. In the present embodiment, the control device 20 may be connected to a device (an ignition device or the like) in the fuel cell module 10, the sensor 30, the gas compressor 40, and the valves (first to fourth valves) via the external interface. The control device 20 may adjust the supply amount of the fuel gas by controlling the first valve 11 and the second valve 12. In addition, the control device 20 may adjust the supply amount of the air by controlling the third valve 13 and the fourth valve 14.

### Sensor

The sensor 30 may be configured to detect various states in the fuel cell module 10. The type of the sensor 30 is not particularly limited, and may be appropriately determined according to the embodiment. In an example, the sensor 30 may include a sensor, such as a temperature sensor 31, a pressure sensor 33, or a gas sensor 35. The temperature sensor 31 may be configured to detect the temperature of the gas in the fuel cell module 10 and the temperature of the fuel cell. The pressure sensor 33 may be configured to detect a pressure of the gas in the fuel cell module 10. The gas sensor 35 may be configured to detect the concentration of a specific gas (hydrogen or the like) in the fuel cell module 10.

### Gas Compressor

The gas compressor 40 is a device that supplies the fuel gas stored in an external bomb or a storage tank to the fuel cell module 10. The gas compressor 40 can continuously supply the gas by compressing the fuel gas. The gas compressor 40 may adjust the supply amount of the fuel gas according to the gas amount in the fuel cell module 10 detected by the sensor 30. The adjustment of the supply amount may be controlled by the control device 20.

### Valve

The valves (the first valve 11, the second valve 12, the third valve 13, and the fourth valve 14) are devices that adjust the flow rate of the fluid passing through the pipes. The type of the valve is not particularly limited as long as the flow rate adjustment is possible, and may be appropriately selected according to the embodiment. For example, the valve may be a valve, such as a gate valve, a ball valve, a check valve, or an adjustment valve. In the present embodiment, the first valve 11 and the second valve 12 control the inflow amount of the fuel gas. The third valve 13 and the fourth valve 14 control the inflow amount of the air. The first valve 11 to the fourth valve 14 may use all valves of the same type or at least one valve type may be different. The fourth valve 14 may be omitted in a case where the air is not injected from the compression device 80 to the second space 120 (no pipe).

### Gas Turbine

The gas turbine 50 has a rotation shaft (shaft) and is a device that performs a rotation motion using an expansion force of the high-temperature gas. The energy generated by the rotation motion of the gas turbine 50 may be transmitted to the generator 60 through the shaft. The gas turbine 50 may be driven using the exhaust gas or the unburned gas supplied from the fuel cell module 10 as an energy source. The type of the gas turbine 50 is not particularly limited, and may be appropriately determined according to the embodiment.

### Generator

The generator 60 is a device that converts the rotation energy transmitted from the gas turbine 50 through the shaft into electrical energy. The type of the generator 60 is not particularly limited, and a known configuration may be adopted. The electric power (alternating current power) generated by the generator 60 may be supplied to the battery 70. In this case, the electric power may be converted into direct current power by a rectifier.

### Battery

The battery 70 is a device for storing and supplying the electric power generated by the fuel cell module 10 and the generator 60. The type of the battery 70 is not particularly limited, and may be appropriately selected according to the embodiment. The electric power stored in the battery 70 may be supplied to any device (module) inside and outside the fuel cell system 1. In an example, the electric power of the battery 70 may be supplied to the fuel cell module 10. Each of the devices (the fuel cell, the ignition device, and the like) in the module may be activated by the control device 20 using the supplied electric power as a power source. In another example, the electric power of the battery 70 may be supplied to the gas compressor 40. In still another example, the electric power of the battery 70 may be supplied to a system external to the fuel cell system 1.

### Compression Device

The compression device 80 is a device for compressing the air taken in from the outside. The compressed air may be supplied to, for example, the fuel cell module 10. The fuel cell module 10 generates high-pressure exhaust gas (and unburned gas) by burning the fuel gas together with the compressed air. The fuel cell module 10 can generate a greater expansion force in the gas turbine 50 by supplying the high-pressure gas to the gas turbine 50. The control device 20 may control the supply of the air from the compression device 80 to the fuel cell module 10. The control device 20 may adjust the supply amount of the air by controlling the valves (the third valve 13 and the fourth valve 14).

### Fuel Cell Module

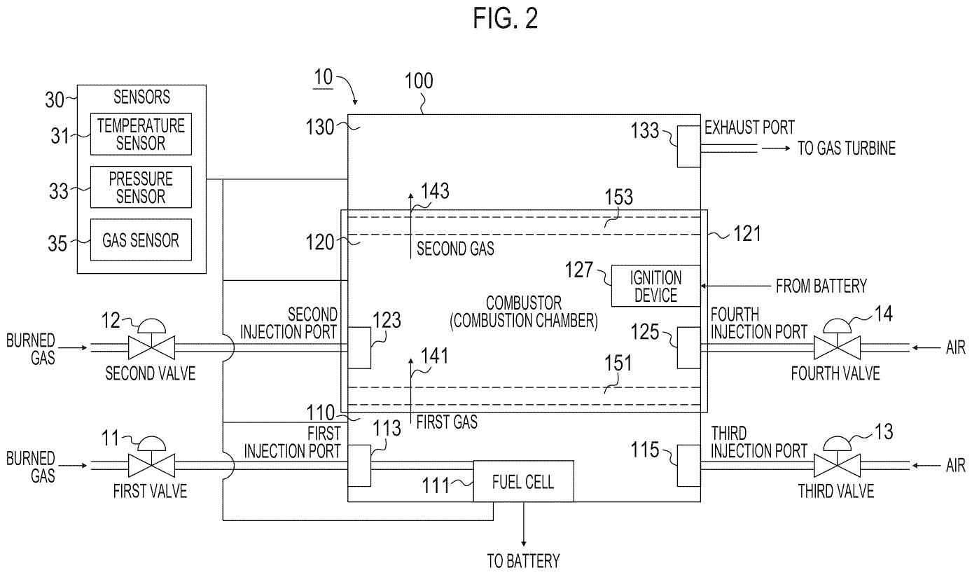

FIG. 2 schematically shows an example of the fuel cell module 10 of the present disclosure. The fuel cell module 10 includes a housing 100, a fuel cell 111, and a combustor 121.

### Housing

The housing 100 has one or more internal spaces, one or more injection ports (the first injection port 113 to the fourth injection port 125, and the like), and one or more discharge ports (the discharge port 133, and the like). The configuration of the housing 100 (size, type, shape, and the like) is not particularly limited as long as the fuel cell 111 and the combustor 121 can be respectively disposed in the internal space, and may be appropriately selected according to the embodiment. The material of the housing 100 may be optionally selected as a material that can withstand the temperature when the fuel cell 111 and the combustor 121 are in use.

One of the internal spaces includes a first space 110, a second space 120, and a third space 130. The fuel cell 111 is disposed in the first space 110. The combustor 121 is disposed in the second space 120. The discharge port 133 is installed in the housing portion of the third space 130. The first space 110 to the third space 130 are referred to by the disposition of the respective components (the fuel cell 111, the combustor 121, the discharge port 133, and the like), and may be interpreted as virtually different spaces or may be substantially distinguishable by the disposition of a partition, such as a ceramic foam.

### Fuel Cell

The fuel cell 111 generates electric power by a chemical reaction between hydrogen contained in fuel and oxygen contained in air. As described above, the fuel cell 111 may be disposed in the first space 110 and may chemically react the fuel gas injected from the first injection port 113 and the air injected from the third injection port 115. The fuel gas may be directly supplied to the fuel cell 111 via the first injection port 113. The fuel gas may be reformed by a reformer before being supplied to the fuel cell 111. The generated electric power is transmitted to the battery 70 outside the fuel cell module 10. In addition, the unreacted fuel gas may be self-ignited when the space in which the fuel cell 111 is disposed is at a high temperature (for example, 600° C. or higher). The exhaust gas after the fuel gas is self-ignited may be supplied to an external device, such as a gas turbine.

The configuration (size, type, shape, and the like) of the fuel cell 111 is not particularly limited, and may be appropriately determined according to the embodiment. In an example, the fuel cell 111 may include a solid oxide fuel cell, a phosphoric acid fuel cell, a molten carbonate fuel cell, a solid polymer electrolyte fuel cell, or the like. In addition, the size and the shape of the fuel cell 111 may be appropriately determined. The fuel used for the fuel cell 111 may include a fuel gas, such as hydrogen, natural gas, biogas, or city gas.

### Combustor

The combustor 121 is a device for burning the fuel gas to obtain thermal energy. The configuration of the combustor 121 (size, type, shape, and the like) is not particularly limited as long as the fuel gas can be burned, and may be appropriately selected. In an example, the combustor 121 may include at least a combustion chamber and an ignition device 127. The combustion chamber is a space for mixing the fuel gas and the air and burning the fuel gas and the air. The exhaust gas generated in the combustion chamber may be supplied to an external device, such as a gas turbine. The ignition device 127 is a device for igniting and burning the mixed fuel gas and air. The type of the ignition device 127 is not particularly limited, and may be appropriately selected.

As described above, the combustor 121 may be disposed in the second space 120 and may burn the fuel gas injected from the second injection port 123 and the air injected from the fourth injection port 125 in the combustion chamber. The ignition device 127 may be used for combustion. The combustor 121 being disposed in the second space 120 may include the combustor 121 being independently installed in the second space 120 and the combustor 121 being configured to be integrated with a part or all of the second space 120. In the example of FIG. 2, the combustor 121 is configured to be integrated with all of the second space 120. That is, the entire second space 120 is the combustor 121.

In a case where the combustor 121 is independently installed in the second space 120, the combustor 121 may include one or more injection ports for injecting the fuel gas and the air into the combustion chamber. Further, the combustor 121 may include one or more discharge ports for discharging the exhaust gas after combustion to the outside. In this case, the fuel gas may be directly supplied to the combustion chamber via the second injection port 123. In addition, the air may be directly supplied to the combustion chamber via the fourth injection port 125.

In a case where the combustor 121 is configured by a part of the second space 120, the injection port of the fuel gas of the combustor 121 may be the same as the second injection port 123 or may be different from the second injection port 123. The injection port of the air of the combustor 121 may be the same as the fourth injection port 125 or may be different from the fourth injection port 125. In addition, the partition 151 between the first space 110 and the second space 120, and the partition 153 between the second space 120 and the third space 130 may be configured as a part of the combustor 121 (outer wall), or may not be configured as a part of the combustor 121.

In a case where the combustor 121 is configured by all of the second space 120, the injection port of the fuel gas of the combustor 121 may be the same as the second injection port 123. The injection port of the air of the combustor 121 may be the same as the fourth injection port 125. In addition, the inside of the second space 120 may be a combustion chamber. At this time, the partition 151 between the first space 110 and the second space 120, and the partition 153 between the second space 120 and the third space 130 may be interpreted as being included in a part of the combustor 121 (outer wall).

### First Space

The first space 110 is, as described above, a space in which the fuel cell 111 is disposed. The place where the fuel cell 111 is disposed in the first space 110 may be optionally decided. The first injection port 113 and the third injection port 115 may be provided in the housing portion of the first space 110. The first space 110 may allow inflow of the fuel gas supplied from the gas compressor 40 through the first injection port 113. In addition, the first space 110 may allow inflow of the air from the outside through the third injection port 115. The first space 110 discharges the first gas 141 including the exhaust gas and the unreacted gas as a result of the chemical reaction by the fuel cell 111. The first gas 141 may be configured to be discharged to the second space 120.

### Second Space

The second space 120 is, as described above, a space in which the combustor 121 is disposed. The place where the combustor 121 is disposed in the second space 120 may be optionally decided. The second injection port 123 and the fourth injection port 125 may be provided in the housing portion of the second space 120. The second space 120 may allow inflow of the fuel gas supplied from the gas compressor 40 through the second injection port 123. In addition, the second space 120 may allow inflow of the air from the outside through the fourth injection port 125. Further, the second space 120 may allow inflow of the first gas 141 discharged from the first space 110. The second space 120 discharges the second gas 143 including the exhaust gas and the unburned gas as a result of the combustion by the combustor 121. The second gas 143 may be configured to be discharged to the third space 130.

### Third Space

The third space 130 is, as described above, a space in which the discharge port 133 is installed in the housing portion. The place where the discharge port 133 is installed in the housing portion of the third space 130 may be optionally decided. The third space 130 may discharge the second gas 143 discharged from the second space 120 to the outside through the discharge port 133.

The third space 130 may be omitted. In this case, the discharge port 133 may be installed in the housing portion of the second space 120. At this time, the second gas 143 generated in the second space 120 may be discharged to the outside through the discharge port 133. In addition, the partition 153 may also be omitted.

### Positional Relationship Between Spaces

In the internal space of the housing 100, the second space 120 is continuous with the first space 110. Further, the third space 130 is continuous with the second space 120 and is connected to the first space 110 via the second space 120. In a case where the positional relationship as described above is provided, the disposition places of the first space 110, the second space 120, and the third space 130 in the housing 100 are not particularly limited, and may be appropriately decided. In an example, the first space 110, the second space 120, and the third space 130 may be disposed in this order from the bottom of the housing 100. As a result, it is possible to efficiently cause the gas (the first gas 141 and the second gas 143) generated and increased in each of the spaces to flow into the adjacent space.

The method of partitioning each of the spaces is not particularly limited as long as the gas (the first gas 141 and the second gas 143) in each of the spaces is configured to be ventilated, and may be appropriately selected according to the embodiment. In an example, each of the spaces may be partitioned by a partition (151, 153) that allows the gas to be ventilated. The partition may include a partition wall, a membrane, a porous material, or the like. For example, the partition may include a ceramic foam. The ceramic foam is a filter having a porous structure. The second space 120 can stably hold heat and can improve the combustion efficiency of the combustor 121 by being partitioned with the ceramic foam. The method of partitioning the first space 110 and the second space 120 may be the same as the method of partitioning the second space 120 and the third space 130, or may be different from the method of partitioning the second space 120 and the third space 130.

In the present embodiment, as described above, the first space 110 in which the fuel cell 111 is disposed and the second space 120 in which the combustor 121 is disposed are continuous. As a result, the combustor 121 (second space 120) can easily transmit the combustion heat generated by combustion to the first space 110 adjacent to the second space 120. Therefore, in a case where the fuel cell module 10 is configured as described above, it is possible to quickly perform the warm-up of the fuel cell 111 by operating the combustor 121 at the time of activation of the fuel cell system 1.

### 2. Operation Example

In the present embodiment, the control device 20 may perform control for enabling stable and quick power generation at the time of activation and at the time of steadiness of the fuel cell module 10 on each of the components of the fuel cell system 1. In the following operation example, the fuel cell 111 may be a cell that operates in a high temperature state. In an example, the fuel cell 111 may be a solid oxide fuel cell. The following processing procedure is merely an example, and each step may be changed as much as possible. In addition, the following processing procedure can be appropriately modified by omitting, replacing, and adding steps according to the embodiment.

### Control at Time of Activation of Fuel Cell Module

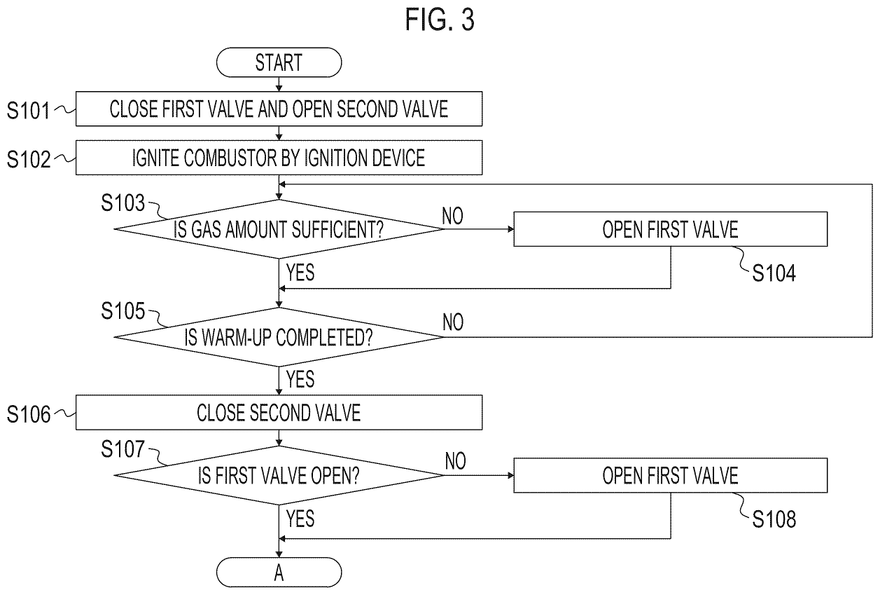

FIG. 3 is a flowchart showing an example of a processing procedure of the control device 20 at the time of activation of the fuel cell module 10 of the present disclosure. The present processing procedure is a series of processing until the fuel cell module 10 reaches the steady state (A). The steady state represents a state in which the fuel cell 111 is stably operable after the warm-up is completed and the gas turbine 50 is stably drivable by the exhaust gas from the discharge port 133.

In S101, the control device 20 closes the first valve 11 and opens the second valve 12. As a result, the fuel gas is injected solely into the second injection port 123 of the housing 100. In S102, the control device 20 ignites the combustor 121 by operating the ignition device 127.

In S103, the control device 20 determines whether the gas amount in the second space 120 is sufficient. The determination condition may be appropriately defined. The control device 20 may detect the gas amount in the second space 120 from the gas sensor 35 and use the gas amount for determination. In an example, the control device 20 may determine that the gas amount is sufficient in response to the gas amount being greater than a predetermined threshold value. When the control device 20 determines that the gas amount is not sufficient, the control device 20 proceeds to S104 with the process. On the other hand, in a case where the control device 20 determines that the gas amount is sufficient, the control device 20 proceeds to S105 with the process.

In S104, the control device 20 opens the first valve 11 and injects the fuel gas into the first space 110. As a result, the gas amount in the second space 120 is increased by the gas flowing in from the first space 110. When the control of opening the first valve 11 is completed, the control device 20 proceeds with the process to S105.

In S105, the control device 20 determines whether the warm-up of the fuel cell 111 is completed. The determination condition for the completion of the warm-up may be appropriately defined. The control device 20 may detect the temperature of the fuel cell 111 from the temperature sensor 31 and use the temperature for determination. In an example, the control device 20 may determine that the warm-up of the fuel cell 111 is completed in response to the temperature of the fuel cell 111 being greater than a predetermined threshold value. The threshold value that is predetermined may be appropriately defined. In an example, the control device 20 may store a threshold value for each type of fuel cell in the storage unit. The control device 20 may set the threshold value according to the type of the fuel cell. When the control device 20 determines that the warm-up is not completed, the control device 20 returns the process to S103. On the other hand, in a case where the control device 20 determines that the warm-up is completed, the control device 20 proceeds with the process to S106.

In S106, the control device 20 closes the second valve 12. In S107, the control device 20 detects whether the first valve 11 is open. When the first valve 11 is not open, the control device 20 proceeds with the process to S108 and opens the first valve 11. When the warm-up of the fuel cell 111 is completed and the state in which solely the first valve 11 is open is achieved, the control device 20 ends the present processing procedure.

### Control at Time of Steadiness of Fuel Cell Module

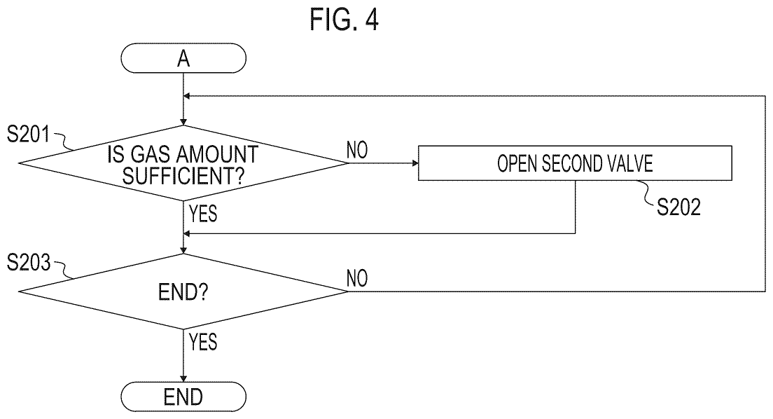

FIG. 4 is a flowchart showing an example of a processing procedure of the control device 20 in a steady state (A) of the fuel cell module 10 of the present disclosure.

In S201, the control device 20 determines whether the gas amount in the second space 120 is sufficient. The determination condition may be defined in the same manner as in S103. When the control device 20 determines that the gas amount is not sufficient, the control device 20 proceeds to S202 with the process. On the other hand, in a case where the control device 20 determines that the gas amount is sufficient, the control device 20 proceeds with the process to S203.

In S202, the control device 20 opens the second valve 12 and injects the fuel gas into the second space 120. As a result, the gas amount in the second space 120 is increased, and thus the gas amount at a high temperature generated by combustion is increased. When the gas amount is increased, the gas turbine 50 can be stably driven. When the control of opening the second valve 12 is completed, the control device 20 proceeds with the process to S203.

In S203, the control device 20 determines whether to end the operation of the fuel cell module 10. The determination of whether to end the operation of the fuel cell module 10 may be made based on any criterion. For example, the control device 20 may determine not to end the operation of the fuel cell module 10 until any end instruction is given. On the other hand, in a case where the end instruction is given, the control device 20 may determine to end the operation of the fuel cell module 10. When the control device 20 determines not to end the operation, the control device 20 may return the process to S201. When the control device 20 determines to end the operation, the control device 20 ends the present processing procedure.

### 3. Features

In the present embodiment, the second space 120 in which the combustor 121 is disposed is adjacent to the first space 110 in which the fuel cell 111 is disposed. As a result, in S101 to S102 at the time of activation of the fuel cell module 10, the fuel cell 111 can promptly complete warm-up by obtaining the thermal energy transmitted from the second space 120. As a result of the early warm-up of the fuel cell 111 being possible, the waiting time of the fuel cell 111 is reduced, and thus the fuel cell system 1 can expect to improve the power generation efficiency. In particular, in a case where the fuel cell 111 is a fuel cell such as a solid oxide fuel cell, the operation temperature of the fuel cell 111 is high, about 700° C. to 1,000° C. In such a case, it is desirable to promote the warm-up of the fuel cell 111 in order to quickly activate the fuel cell 111.

### 4. Modification Example

Although the embodiments of the present disclosure have been described in detail above, the description up to the above is merely an example of the present disclosure in all respects. It goes without saying that various improvements or modifications can be made without departing from the scope of the present disclosure. The processing and means described in the present disclosure can be implemented in any combination as long as no technical inconsistencies arise.

What is claimed is:

1. A fuel cell module comprising:
a housing including an internal space;
a fuel cell; and
a combustor, wherein:
the internal space includes a first space, a second space continuous with the first space, and a third space continuous with the second space and connected to the first space via the second space;
the fuel cell is disposed in the first space;
the combustor is disposed in the second space;
the second space is configured to allow inflow of a first gas discharged from the first space; and
the third space is configured to allow inflow of a second gas discharged from the second space, and a discharge port for discharging the second gas to an outside of the housing is provided in a housing portion of the third space.

2. The fuel cell module according to claim 1, wherein the fuel cell is a solid oxide fuel cell.

3. The fuel cell module according to claim 1, wherein the first space and the second space are partitioned by a ceramic foam, and the second space and the third space are partitioned by a ceramic foam.

4. The fuel cell module according to claim 1, wherein the first space, the second space, and the third space are disposed in an order of the first space, the second space, and the third space from a lower side in the housing.

5. The fuel cell module according to claim 1, wherein an injection port for injecting air compressed by an external compression device is provided in a housing portion of the first space in the internal space.
